(19) United States
(12) Patent Application Publication
(10) Pub. No.: US 2006/0159531 A1
(43) Pub. Date: Jul. 20, 2006

(54) Core drilling tool and core drilling machine

(76) Inventors: Joerg Bortz, Lichtenstein (DE); Juergen Wiehler, Engstingen (DE)

Correspondence Address: ST. ONGE STEWARD JOHNSTON & REENS, LLC, 986 BEDFORD STREET, STAMFORD, CT, 06905-5619, US

(21) Appl. No.: 11/317,125

(22) Filed: Dec. 22, 2005

(30) Foreign Application Priority Data
Dec. 22, 2004 (DE) 10 2004 062 912.9

(51) Int. Cl. B23B 51/04

(52) U.S. Cl. 408/204

(57) ABSTRACT

A core drilling tool and an associated core drilling machine are disclosed. An advantageous and permanent connection is ensured between the core drilling tool and the core drilling machine by means of a form-fitting element on the core drilling tool and an assigned form-fitting counterelement on a tool-holding fixture of the core drilling machine. Interlatching between the core drilling tool and the tool-holding fixture of the core drilling machine is made possible via latching elements of the tool-holding fixture preferably only when the form-fitting connection between the form-fitting element and the form-fitting counterelement is effected.

### CROSS-REFERENCE TO RELATED APPLICATIONS

The present application claims priority of German Patent Application No. 10 2004 062 912.9 on Dec. 22, 2004.

### BACKGROUND OF THE INVENTION

The invention relates to a drilling tool, in particular a core drilling tool, and to a drilling machine comprising a suitable tool-holding fixture for the reception of a drilling tool of this type.

DE 44 22 342 C2 discloses a core drill and a core drilling machine comprising a tool-holding fixture suitable for the reception of a core drill of this type. In this case, the core drilling tool has a shank for fastening to an assigned tool-holding fixture of a core drilling machine, the shank being designed cylindrically and having a plurality of depressions, into which balls of the assigned tool-holding fixture of the core drilling machine can engage. When a core drilling tool is pushed into the tool-holding fixture, balls held movably in the tool-holding fixture enter the depressions of the shank of the core drilling tool and then allow force transmission between the core drilling machine and the core drilling tool.

This design has the disadvantage that torque transmission is brought about solely via the balls. This may lead to premature wear, particularly since core drilling tools are exposed to high torques.

### SUMMARY OF THE INVENTION

It is an object of the invention to disclose a core drilling tool and a core drilling machine having a tool-holding fixture which can engage the core drilling tool so as to allow for an improved torque transmission from the tool-holding fixture to the core drilling tool.

This and other objects of the invention are achieved, according to the invention, by means of a core drilling tool, in particular a core drill, comprising a shank for fastening to an assigned tool-holding fixture of a core drilling machine, the shank having at least one depression for the reception of at least one latching element of the tool-holding fixture, the core drill comprising a form-fitting element which is offset axially with respect to the depression and is designed for form-fitting connection to a form-fitting counterelement provided on the tool-holding fixture.

Furthermore, the object of the invention is achieved by means of a core drilling machine comprising a drive for driving a tool-holding fixture having a pot-shaped extension with a cavity into which a core drilling tool can be inserted with its shank, and having at least one radially movable latching element which allows interlatching with an assigned depression on the shank of a core drilling tool introduced into the tool-holding fixture, there being provided on the inner wall of the cavity a form-fitting counterelement which is offset axially with respect to the at least one latching element and is designed for form-fitting connection to a form-fitting element of the core drilling tool.

The object of the invention is in this way achieved in full.

To be precise, according to the invention, irrespective of the latching elements used, a form-fitting element and a form-fitting counterelement on the core drilling tool, on the one hand, and on the core drilling machine, on the other hand, are now used, in order to ensure a form-fit between the core drilling tool and the core drilling machine.

Thus, according to the invention, a secure connection between the core drilling tool and the core drilling machine is now ensured by means of a form-fit, without the balls used in the prior art being used in this case in order to produce a form-fit. Additionally, however, the at least one latching element on the tool-holding fixture and the at least one assigned depression on the core drilling tool are provided, in order to make it possible that core drilling tools according to the invention can also be chucked on conventional core drilling machines.

In an advantageous development of the invention, the depression on the shank is designed as a circumferential groove.

One or more latching elements can thus be used in order to allow interlatching between the circumferential groove of the shank and the tool-holding fixture. By the depression being configured as a circumferential groove, this ensures that no torques of any kind are transmitted via the latching elements.

The form-fitting element of a shank may preferably be designed as a polygon, in particular as a square, a hexagon or an octagon.

Correspondingly, the form-fitting counterelement on the tool-holding fixture may be designed as a polygon, in particular as a square, a hexagon or an octagon.

According to a further refinement of the invention, the form-fitting element is provided at that end of the shank which faces away from the outer end, and the at least one depression is arranged so as to be offset axially in the direction of the outer end of the shank.

Correspondingly, according to a further refinement of the invention, the form-fitting counterelement on the tool-holding fixture is provided at the outer end of the inner wall of the cavity, the at least one latching element being offset axially with respect to the form-fitting counterelement in the direction of the inner end of the cavity.

By virtue of these measures, it becomes possible respectively for the form-fitting element and the form-fitting counterelement to be offset with respect to the at least one depression and with respect to the at least one latching element in such a way that interlatching with the at least one latching element is made possible only when the form-fitting element engages with a form-fit on the form-fitting counterelement of the tool-holding fixture.

It can thereby be ensured that, when the core drilling tool is pushed into the tool-holding fixture, a proper form-fit between the core drilling tool and the tool-holding fixture is always ensured. For this purpose, the core drilling tool merely has to be introduced in the suitable angular position into the tool-holding fixture and latched.

According to a further refinement of the invention, the shank of the core drilling tool has a cylindrical basic shape and preferably on its outer surface a plurality of flattenings.

The shank can thereby be designed with the conventional features, so that it also becomes possible for core drilling tools according to the invention to be chucked on conventional core drilling machines in which force transmission takes place solely via balls which engage between depressions on the outer surface of the core drilling tools and depressions on the inner surface of the tool-holding fixture. The core drilling tools according to the invention can thus also be used for connection to tool-holding fixtures of the “Weldon®” type.

According to an advantageous development of the invention, three latching elements, which are preferably designed as balls, are arranged radially movably, at uniform angular intervals in relation to one another, in radial bores.

In this case, the latching elements may be secured against falling out outwards by means of a sleeve which surrounds the extension from outside.

In a combination according to the invention of a core drilling machine with a core drilling tool of the type described above, the form-fitting element of the core drilling tool is arranged so as to be offset axially with respect to the at least one depression of the core drilling tool in such a way that interlatching with the at least one latching element is made possible only when the form-fitting element engages with a form-fit onto the form-fitting counterelement of the tool-holding fixture.

This ensures a reliable form-fitting fastening of the core drilling tool on the core drilling machine; and

It goes without saying that the abovementioned features of the invention and those yet to be explained below can be used not only in the combination specified in each case, but also in other combinations or alone, without departing from the scope of the invention.

### BRIEF DESCRIPTION OF THE DRAWINGS

FIG. 1 is Further features and advantages of the invention may be gathered from the following description of a preferred exemplary embodiment, with reference to the drawing in which:

FIG. 1 shows a side view of a core drilling tool according to the invention;

FIG. 2 shows a section through the core drilling tool along the line II-II, and

FIG. 3 shows an assembly drawing in longitudinal section, a core drilling tool according to the invention, as shown in FIGS. 1 and 2, being inserted into an assigned tool-holding fixture of a core drilling machine.

### DETAILED DESCRIPTION OF THE INVENTION

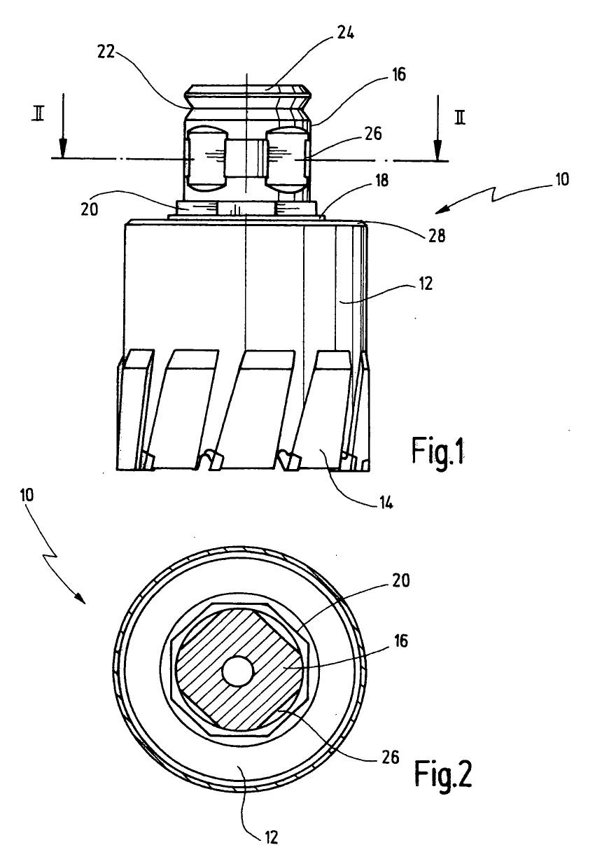

In FIGS. 1 and 2, a core drilling tool according to the invention is designated as a whole by the numeral 10.

The core drilling tool 10 has a pot-shaped drill bit 12 which at its outer edge has a plurality of cutting elements 14 so that a core bore can be produced. The drill bit 12 is closed off by means of a radial end face 28 towards the side lying opposite the cutting elements 14. From an adjoining flanged surface 18 of smaller diameter, a basically cylindrical shank 16 extends in the direction of an outer end 24. An attachment in the form of a form-fitting element 20, which is designed as an octagon, is provided contiguous to the flanged surface 18. This form-fitting element 20 then has adjoining it the shank 16 with its basically cylindrical outer surface. Directly contiguously to the outer end 24 of the shank 16 is provided a depression 22 which is designed as a circumferential groove or annular groove. This depression 22 serves for the reception of latching elements of an assigned tool-holding fixture of a core drilling machine. The shank 16 is provided on its circumferential surface with, overall, four flattenings 26 which make it possible to connect the core drilling tool 10 to a fixture of the Weldon® type which is conventional in the prior art.

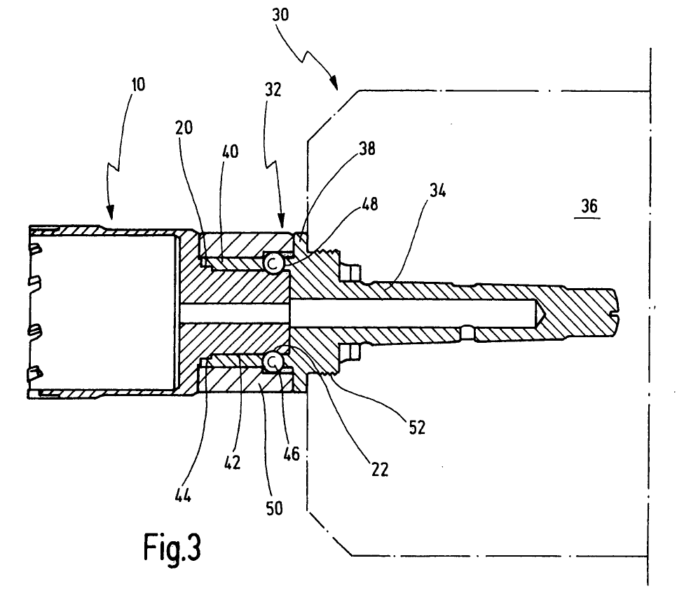

The interaction between a core drilling tool 10 and the tool-holding fixture 32 of an assigned machine tool 30 is explained in more detail below with reference to FIG. 3.

A core drilling machine, designated as a whole by the numeral 30, is illustrated in FIG. 3 solely in its outer region. The core drilling machine 30 has a drive, indicated by the numeral 36, by means of which a shaft portion 34 can be driven in rotation. As illustrated in FIG. 3, the shaft portion 34 may have a conical form of construction and be screwed with the aid of a thread 52 to an element driven in rotation by the drive 36. The tool-holding fixture 32 has an annular collar 38 which projects outwards from the thread 52 and from which a pot-shaped extension 40 extends outwards. A cylindrical cavity 42 is provided in the pot-shaped extension 40. At the outer end of the cavity 42, on the inner wall, a form-fitting counterelement 44 in the shape of an octagon is formed, the shape and size of which are coordinated with the form-fitting element 20 on the core drilling tool 10. In the region of the bottom of the cavity 42, latching elements 46 in the shape of spring-loaded balls are provided in radial bores 48 which pass through the wall of the extension 40. Three latching elements, overall, are arranged at uniform angular intervals of 120° in relation to one another. The radial bores 48 end towards the inside of the cavity 42 with a diameter such that the inserted balls cannot fall into the cavity 42. The balls are secured outwardly against falling out by means of a sleeve 50 pushed onto the outer wall of the extension 40. The sleeve 50 is screwed or otherwise connected, for example by means of a press fit, to the extension 40.

The balls are prestressed inwards in the direction of the cavity 42 by means of spring elements (not illustrated). The sprung balls may be replaced by any other sprung elements, such as, for example, by sprung pins; and

The axial spacing between the latching elements 46 and the assigned depression 22 in the shape of the circumferential groove on the shank 16 of the core drilling tool 10 is selected such that an engagement of the latching elements 46 or of the balls into the depression 22 is made possible only when the form-fitting element 20 of the core drilling tool 10 engages with a form-fit into the form-fitting counterelement 44 at the outer end of the cavity 42.

What is claimed is:

1. A core drill comprising:
a pot-shaped drill bit having a first end formed by a radial end surface and having a second end carrying a plurality of cutting elements;
a shank extending from said radial end surface and being configured for engaging an assigned tool-holding fixture of a core drilling machine;
at least one depression provided on said shank configured for receiving at least one latching element provided on said tool-holding fixture when being in an engaged position in which said shank is received within a cavity of said tool-holding fixture and said latching element is latched with said depression; and
a form-fitting element which is axially offset from said depression toward said radial end surface and is configured for engaging a form-fitting counterelement provided on said tool-holding fixture for effecting a form-fitting connection to said tool-holding fixture when being in said engaged position.

2. The core drill of claim 1, wherein the depression is configured as a circumferential groove.

3. The core drill of claim 1, wherein the form-fitting element is configured as a polygon.

4. The core drill of claim 3, wherein the form-fitting element has a shape selected from the group formed by a square, a hexagon and an octagon.

5. The core drill of claim 1, wherein said form-fitting element is located at an outer end of said shank opposite to said radial surface, and wherein said at least one depression is located axially offset from said form-fitting element toward said radial surface.

6. The core drill of claim 5, wherein said at least one depression is located adjoining the radial end surface so as to allow a latching with said latching element of said tool-holding fixture only when said form-fitting element is engaged with said form-fitting counterelement when being in said engaged position.

7. The core drill of claim 1, wherein said shank has a substantially cylindrical shape.

8. The core drill of claim 7, further comprising a plurality of flattenings provided on an outer surface of said shank.

9. A core drilling machine comprising:
a drive for driving a tool-holding fixture having a pot-shaped extension defining a cavity configured for receiving a shank of a core drilling tool;
at least one radially movable latching element provided on said pot-shaped extension and configured for interlatching with an assigned depression provided on said shank of said core drilling tool when being in an engaged position, in which said shank of said core drilling tool is received within said cavity of said tool-holding fixture;
a form-fitting counterelement provided on an inner wall of said cavity, said form-fitting counterelement being offset axially with respect to said at least one latching element and being configured for effecting a form-fitting connection to a form-fitting element provided on said core drilling tool when being in said engaged position.

10. The core drilling machine of claim 9, wherein said form-fitting counter-element is shaped as a polygon.

11. The core drilling machine of claim 9, wherein said form-fitting counterelement has a shape selected from the group formed by a square, a hexagon and an octagon.

12. The core drilling machine of claim 9, wherein said form-fitting counter-element is provided at an outer end of said cavity, and wherein said at least one latching element is axially offset from said form-fitting counterelement toward an inner end of said cavity.

13. The core drilling machine of claim 9, further comprising at least one bore extending radially from an inner wall of said cavity within said pot-shaped extension, a ball being arranged movably within said at least one bore, thereby defining a latching element.

14. The core drilling machine of claim 9, further comprising three bores being arranged at uniform angular intervals in relation to one another and extending radially from an inner wall of said cavity within said pot-shaped extension, a ball being arranged movably within each of said bores, thereby defining a latching element.

15. The core drilling machine of claim 13, further comprising a sleeve surrounding said pot-shaped extension from the outside for secured said at least one latching element against falling out outwards.

16. A core drilling machine with a core drilling tool, comprising:
a drive for driving a tool-holding fixture having a pot-shaped extension defining a cavity configured for receiving a shank of said core drilling tool;
at least one radially movable latching element provided on said pot-shaped extension and configured for interlatching with an assigned depression provided on said shank of said core drilling tool when being in an engaged position, in which said shank of said core drilling tool is received within said cavity of said tool-holding fixture;
a form-fitting counterelement provided on an inner wall of said cavity, said form-fitting counterelement being offset axially with respect to said at least one latching element and being configured for effecting a form-fitting connection to a form-fitting element provided on said core drilling tool when being in said engaged position.

17. The core drilling machine of claim 16, wherein said form-fitting element of said core drilling tool is arranged so as to be offset axially with respect to said at least one depression of the core drilling tool in such a way that latching with said at least one latching element made possible only when said form-fitting element engages with a form-fit on said form-fitting counterelement of said tool-holding fixture.
